(19) United States
(12) Patent Application Publication
(10) Pub. No.: US 2023/0395093 A1
(43) Pub. Date: Dec. 7, 2023

(54) SOUND PROCESSING DEVICE AND SOUND PROCESSING METHOD

(71) Applicant: Faurecia Clarion Electronics Co., Ltd., Saitama (JP)

(72) Inventors: Chihiro KUWAYAMA, Saitama (JP); Yuki KASHINA, Saitama (JP)

(21) Appl. No.: 18/326,432

(22) Filed: May 31, 2023

(30) Foreign Application Priority Data
Jun. 6, 2022 (JP) 2022-091294

(51) Int. Cl. G10L 25/03; G10L 25/27; G10L 13/02

(52) U.S. Cl. CPC G10L 25/03; G10L 13/02; G10L 25/27

(57) ABSTRACT

A sound processing device, including: a first extracting unit for extracting a first frequency component from an audio signal; a second extracting unit for extracting a second frequency component different from the first frequency component from the audio signal; an amplitude level determining unit for determining if an amplitude level of the second frequency component exceeds a predetermined threshold value; a duration measuring unit for measuring a time during which the amplitude level continues above a predetermined level, when the amplitude level exceeds the predetermined threshold value; an applicable filter determining unit for determining a filter unit to be applied to the second frequency component from a plurality of filter units, based on the duration measured by the duration measuring unit; and a synthesis unit for synthesizing the first frequency component and a frequency component obtained by applying the filter unit to the second frequency component.

### TECHNICAL FIELD

The present invention relates to a sound processing device and a sound processing method.

### BACKGROUND

When music with a high recording level is reproduced, the low-frequency range may become unnaturally strong or be distorted. Furthermore, a sound system with poor convergence may leave a lingering low frequency range for a long period of time, making the user uncomfortable.

In order to improve such low frequency sound quality, a technique for correcting the frequency characteristic of an audio signal by an equalizer, for example, may be used (see, for example, Japanese Unexamined Patent Application 2019-186764).

### SUMMARY

When an equalizer is used, the sound may be unbalanced, for example, by being corrected over a wide frequency range (in other words, even frequency ranges that should not be corrected, in addition to the low frequency range).

Therefore, an object of the present application is to provide a sound processing device and sound processing method suitable for correcting a specific frequency component.

The sound processing device according to an embodiment of the present application includes: a first extracting unit for extracting a first frequency component from an audio signal; a second extracting unit for extracting a second frequency component different from the first frequency component from the audio signal; an amplitude level determining unit for determining if an amplitude level of the second frequency component exceeds a predetermined threshold value; a duration measuring unit for measuring a time during which the amplitude level continues above a predetermined level, when the amplitude level exceeds the predetermined threshold value; an applicable filter determining unit for determining a filter unit to be applied to the second frequency component from a plurality of filter units, based on the duration measured by the duration measuring unit; and a synthesis unit for synthesizing the first frequency component and a frequency component obtained by applying the filter unit determined by the applicable filter determining unit to the second frequency component.

One embodiment of the present application provides a sound processing device and sound processing method suitable for correcting a specific frequency component.

### BRIEF DESCRIPTION OF THE DRAWINGS

FIG. 1 is a block diagram showing a configuration of a sound system according to an embodiment of the present application;

FIG. 2 is a functional block diagram of a sound processing device according to an embodiment of the present application;

FIG. 3 is a flowchart showing a process executed by a reverberation detecting unit and a filter correcting unit included in a sound processing device according to an embodiment of the present application;

FIG. 4A is a diagram showing amplitude characteristics of a original audio signal output from a sound source according to an embodiment of the present application;

FIG. 4B is a diagram showing amplitude characteristics of an audio signal after LPF (Low Pass Filter) processing according to an embodiment of the present application;

FIG. 4C is a diagram showing amplitude characteristics of an audio signal after LPF processing according to an embodiment of the present application;

FIG. 5 is a diagram showing reverberation time corresponding to each waveform including the peak shown in FIG. 4C;

FIG. 6 is a diagram showing a frequency response of an audio signal when HPF (High Pass Filter) processing has been applied according to an embodiment of the present application;

FIG. 7 is a diagram for describing an example of setting the suppression level of a peaking filter unit according to an embodiment of the present application;

FIG. 8 is a diagram showing a frequency response of an audio signal when peaking filter processing has been applied according to an embodiment of the present application; and

FIG. 9 is a functional block diagram of a filter correcting unit according to an embodiment of the present application.

### DETAILED DESCRIPTION OF EMBODIMENTS

The following description relates to a sound processing device and sound processing method according to an embodiment of the present application.

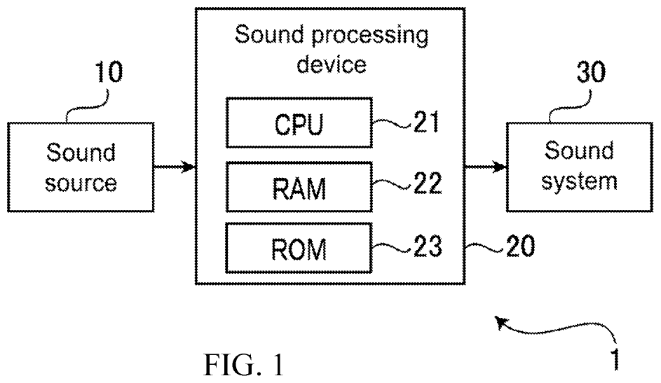

FIG. 1 is a block diagram showing a configuration of a sound system 1 according to an embodiment of the present application. As shown in FIG. 1, the sound system 1 includes a sound source 10, a sound processing device 20, and a sound system 30.

Examples of the sound source 10 include disc media such as CDs (Compact Disc), SACDs (Super Audio CD), and the like that store digital audio data and storage media such as HDDs (Hard Disk Drive), USBs (Universal Serial Bus), and the like.

The sound processing device 20 is an example of a computer, and is configured as an LSI (Large Scale Integration), for example. The sound processing device 20 includes a CPU (Central Processing Unit) 21, RAM (Random Access Memory) 22, and flash ROM (Read Only Memory) 23.

The CPU 21 is a single processor or a multiprocessor, for example, and includes at least one processor. When configured to include a plurality of processors, the CPU 21 may be packaged as a single device, or may include multiple devices physically separated within the sound processing device 20.

The CPU 21 may be referred to as a control unit, ECU (Engine Control Unit), MPU (Micro Processor Unit) or MCU (Micro Controller Unit), for example.

The RAM 22 temporarily holds data and programs. The RAM 22 holds programs and data read from the flash ROM 23, as well as other data necessary for communication.

The flash ROM 23 is a nonvolatile semiconductor memory such as flash memory, EPROM (Erasable Programmable ROM), EEPROM (Electrically Erasable Programmable ROM), and the like. The flash ROM 23 stores programs and data used by the CPU 21 to perform various processes.

The CPU 21 reads programs and data stored in the flash ROM 23 and uses RAM 22 as a work area to comprehensively control the sound processing device 20. In other words, the sound processing device 20 is operated by the CPU 21 executing the program.

In summary, the CPU 21 extracts a first frequency component from an audio signal input from a sound source 10 by executing a program deployed in a work area, and extracts a second frequency component different from the first frequency component from the audio signal; determines if an amplitude level of the second frequency component exceeds a predetermined threshold value; measures a time during which the amplitude level continues above a predetermined level when the amplitude level exceeds the predetermined threshold value; determines a filter unit to be applied to the second frequency component from a plurality of filter units, based on the duration measured; and synthesizes the first frequency component and a frequency component obtained by applying the filter unit determined to the second frequency component. This results in favorable correction of a specific frequency component (the second frequency component) of the audio signal.

For example, if the second frequency component is a low frequency component, the correction can avoid, for example, too strong low frequencies that sound unnatural to the auditory sense, and can also avoid low frequency distortion. In addition, even in a sound system with poor convergence, it is possible to avoid only the low range lingering for a long time.

The sound system 30 includes a D/A converter, amplifier, speaker, and the like. The sound system 30 converts the corrected audio signal input from the sound processing device 20 into an analog signal, amplifies the converted analog signal using the amplifier, and outputs the signal from the speakers. As a result, music of the sound source 10 is reproduced, for example.

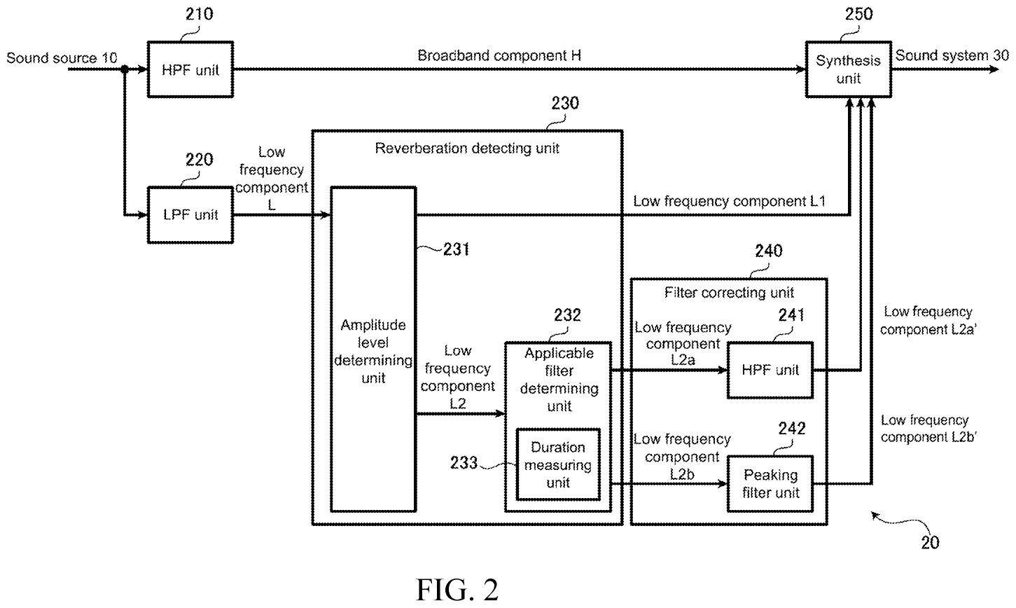

FIG. 2 is a functional block diagram of the sound processing device 20. As shown in FIG. 2, the sound processing device 20 includes, as functional blocks, an HPF unit 210, LPF unit 220, reverberation detecting unit 230, filter correcting unit 240, and synthesis unit 250.

The HPF unit 210 is an example of a first extracting unit including an HPF. The HPF unit 210 extracts a high frequency component H (an example of the first frequency component) from the audio signal input from the sound source 10 and outputs the component to the synthesis unit 250. In the HPF unit 210, the cutoff frequency may be set in advance or may be set arbitrarily by a user operation.

The LPF unit 220 is an example of a second extracting unit including an LPF. The LPF unit 220 extracts a low frequency component L (an example of the second frequency component) from the audio signal input from the sound source 10 and outputs the component to the reverberation detecting unit 230. In the LPF unit 220 as well, the cutoff frequency may be set in advance or may be set arbitrarily by a user operation.

The reverberation detecting unit 230 includes an amplitude level determining unit 231 and an applicable filter determining unit 232. The reverberation detecting unit 230 detects a reverberation level and reverberation time of the low frequency component L and determines the filter unit to be applied to the low frequency component L.

The amplitude level determining unit 231 determines if the amplitude level of the low frequency component L input from the LPF unit 220 exceeds the threshold value X (an example of a predetermined threshold value). The amplitude level determining unit 231 outputs the low frequency component L (for convenience, referred to as “low frequency component L1”) input from the LPF unit 220 to the synthesis unit 250. However, only when the amplitude level of the low frequency component L exceeds the threshold value X, the amplitude level determining unit 231 outputs the low frequency component L (for convenience, referred to as “low frequency component L2”) for a certain period of time after the threshold value X is exceeded, to the applicable filter determining unit 232.

The applicable filter determining unit 232 includes a duration measuring unit 233. The duration measuring unit 233 measures the duration of the low frequency component L2 input from the amplitude level determining unit 231. The duration is the time that the amplitude level of the low frequency component L continues above a predetermined level after the amplitude level of the low frequency component L exceeds a predetermined threshold value in the low frequency component L input from the LPF unit 220, and can also be referred to as the reverberation time of the high level low frequency component L2. The duration is hereafter referred to as the “reverberation time RT”.

In the present embodiment, the reverberation time RT may be, for example, the time from the peak when the amplitude level exceeds the threshold X until the level attenuates by 60 dB, based on the concept of a reverberation time RT60. In this case, the amplitude level 60 dB below the peak is the aforementioned “predetermined level.” The duration measuring unit 233 may measure the time from peak to 20 dB or 30 dB attenuation, based on the reverberation time RT20 or RT30, and then estimate the reverberation time RT based on the measured time.

The applicable filter determining unit 232 determines the filter unit to be applied to the low frequency component L2 from the plurality of types of filter units, based on the reverberation time RT measured by the duration measuring unit 233. In the present embodiment, the plurality of filter units are the first filter unit and the second filter unit included in the filter correcting unit 240.

The applicable filter determining unit 232 determines the first filter unit as the applicable filter unit when the reverberation time RT is greater than a predetermined time t. The applicable filter determining unit 232 outputs the low frequency component L2a of the low frequency component L2 input from the amplitude level determining unit 231 for the period of time corresponding to the reverberation time RT that exceeds the predetermined time t to the HPF unit 241 (an example of the first filter unit) of the filter correcting unit 240.

The applicable filter determining unit 232 determines the second filter unit as the applicable filter unit when the reverberation time RT is less than a predetermined time t. The applicable filter determining unit 232 outputs the low frequency component L2b of the low frequency component L2 input from the amplitude level determining unit 231 for the period of time corresponding to the reverberation time RT that is less than the predetermined time t to the peaking filter unit 242 (an example of the second filter unit) of the filter correcting unit 240.

In this manner, the applicable filter determining unit 232 determines the filter unit to be applied to the low frequency component L2 from the plurality of types of filter units, based on the reverberation time RT measured by the duration measuring unit 233. More precisely, the applicable filter determining unit 232 determines the first filter unit from the plurality of types of filter units as the filter unit to be applied to the low frequency component L2 when the reverberation time RT is longer than a predetermined time t. Furthermore, the applicable filter determining unit 232 determines the second filter unit from the plurality of types of filter units as the filter unit to be applied to the low frequency component L2 when the reverberation time RT is less than a predetermined time t.

The HPF unit 241, which is an example of the first filter unit, cuts the low frequency components in the low frequency component L2a during the period of time corresponding to the reverberation time RT that exceeds the predetermined time t, and outputs the low frequency component L2a′ with this low frequency component cut to the synthesis unit 250.

The peaking filter unit 242, which is an example of the second filter unit, suppresses specific frequency components in the low frequency component L2b for the period of time corresponding to the reverberation time RT less than the predetermined time t, and outputs the low frequency component L2b′ with specific frequency components suppressed to the synthesis unit 250. In more detail, the peaking filter unit 242 detects the peak frequency fp whose amplitude peaks in the low frequency component L2b, and sets the detected peak frequency fp as the center frequency fc of the peaking filter unit 242. Furthermore, the peaking filter unit 242 sets the suppression level at the center frequency based on the peak level at the peak frequency fp.

The synthesis unit 250 synthesizes the high frequency component H and the frequency component obtained by applying the filter unit determined by the applicable filter determining unit 232 to the low frequency component L2. More precisely, the synthesis unit 250 synthesizes the high frequency component H and the low frequency component L1, or the high frequency component H and the low frequency component L2a′, or the high frequency component H and the low frequency component L2b′.

The synthesis unit 250 outputs the synthesized audio signal to the sound system 30. This allows the music to be reproduced with improved low frequency sound quality.

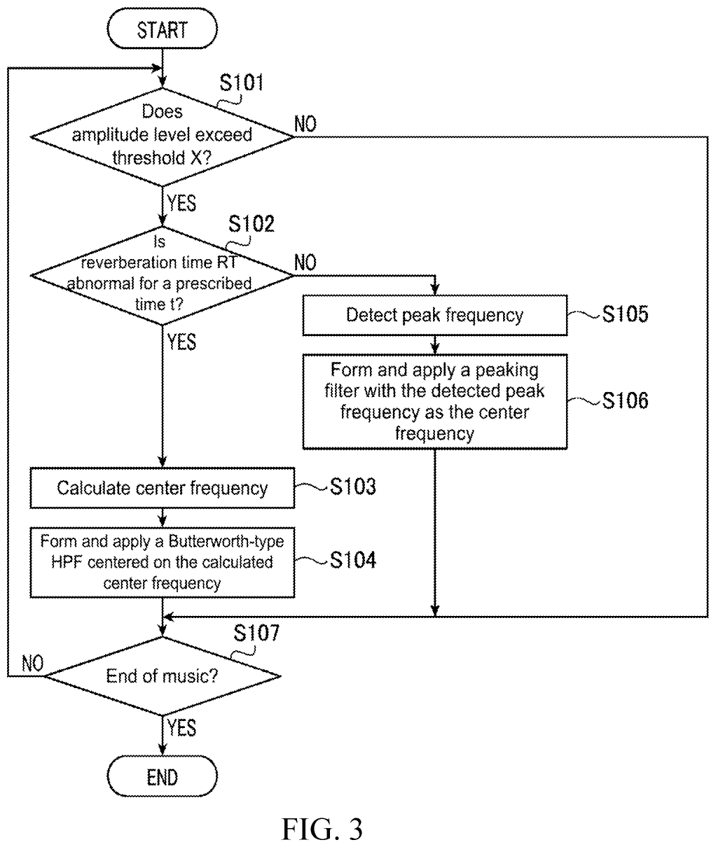

FIG. 3 is a flowchart showing a process executed by a reverberation detecting unit 230 and a filter correcting unit 240 included in a sound processing device 20. For example, when playback of a piece of music from the sound source 10 is started, execution of the process shown in FIG. 3 begins.

The amplitude level determining unit 231 of the reverberation detecting unit 230 determines if the amplitude level of the low frequency component L input from the LPF unit 220 exceeds the threshold value X (step S101).

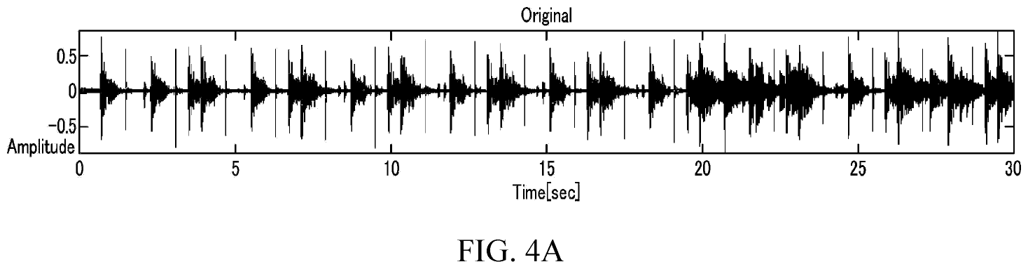

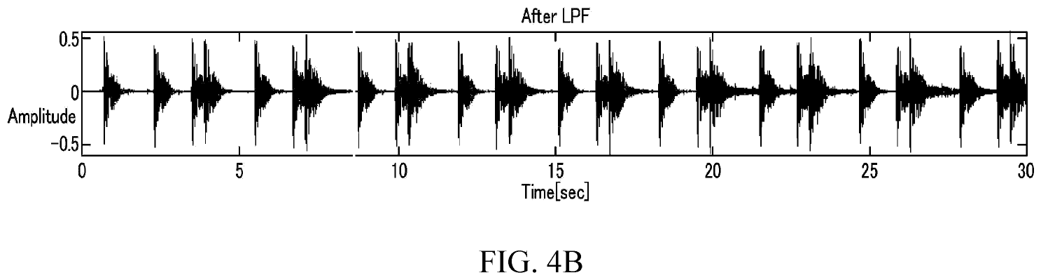

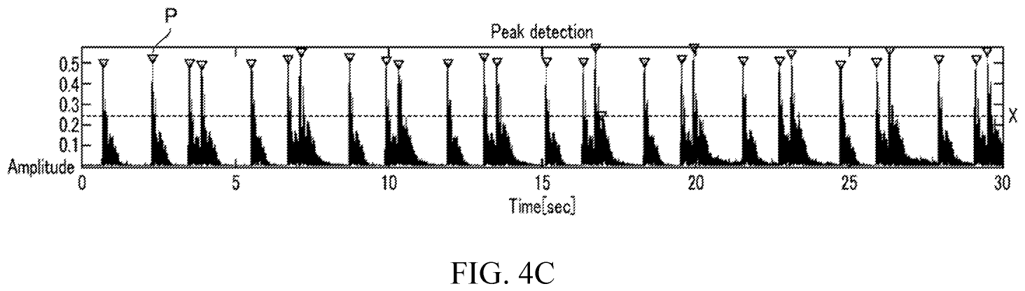

FIG. 4A is a diagram showing the original audio signal output from the sound source 10. FIG. 4B and FIG. 4C are diagrams showing the low frequency component L (in other words, the audio signal after LPF processing) output from the LPF unit 220. In other words, FIG. 4C illustrates the absolute value of the low frequency component L output from the LPF unit 220 (or the average value thereof if the signal has a plurality of channels). In each of FIG. 4A through FIG. 4C, the vertical axis indicates amplitude (without units due to being normalized values) and the horizontal axis indicates time (in seconds).

As can be seen by comparing FIG. 4A with FIG. 4B and FIG. 4C, peaks in the low frequency range are easier to detect by applying LPF processing to the original audio signal output from the sound source 10.

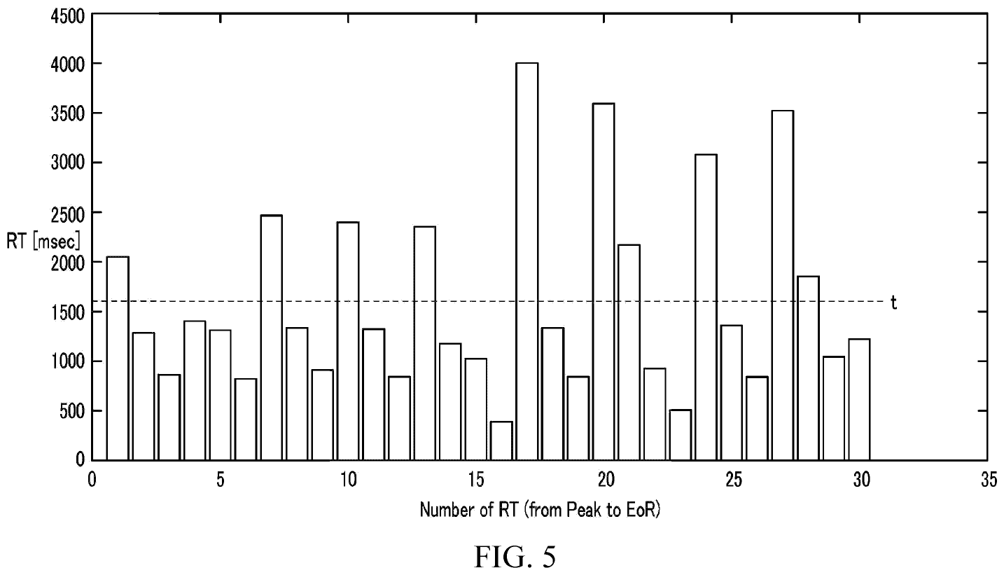

In FIG. 4C, inverted triangles mark the peaks where the amplitude level exceeds the threshold value X. For convenience, the peak marked with an inverted triangle will be referred to as “Peak P.” FIG. 5 is a diagram showing reverberation time RT corresponding to each waveform including peak P. In FIG. 5, the vertical axis indicates the reverberation time RT (unit: seconds), and the horizontal axis indicates the number assigned for convenience to each of the waveforms containing peak P.

A case in which the amplitude level of the low frequency component L input from the LPF unit 220 is less than the threshold value X (step S101: NO) is described. In this case, the amplitude level of the low frequency component L is small, so the low frequency range is less likely to be audibly strong, and low frequency distortion is also less likely to occur. In addition, having only lingering low frequency reverberations for long periods of time will not readily occur, even in a sound system with poor convergence.

Therefore, the low frequency component L1, which has a low amplitude level, is output to the synthesis unit 250 without being filtered in the filter correcting unit 240. In the synthesis unit 250, the high frequency component H and the low frequency component L1 are synthesized and output to the sound system 30. When music from the sound source 10 is finished (step S107: YES), processing of this flowchart ends; but if music of the sound source 10 is not finished (step S107: NO), processing of this flowchart returns to step S101.

A case in which the amplitude level of the low frequency component L input from the LPF unit 220 exceeds the threshold value X (step S101: YES) is described. In this case, the amplitude level of the low frequency component L is large, so the low frequency range may sound unnaturally strong or distorted to the auditory sense, and a sound system with poor convergence may leave only a lingering low frequency range for a long period of time.

Therefore, the low frequency component L2 for a certain amount of time after exceeding the threshold X is output to the applicable filter determining unit 232 for filter processing in the filter correcting unit 240. However, the degree of influence on sound quality degradation due to strong low frequency varies depending on the reverberation time RT. If the low frequency range is not properly corrected based on this degree of influence, for example, sound quality can be degraded by excessively suppressing the low frequency range.

Therefore, the duration measuring unit 233 of the applicable filter determining unit 232 determines whether the reverberation time RT of the low frequency component L2 exceeds a predetermined time t (step S102).

The case in which the reverberation time RT of the low frequency component L2 exceeds the predetermined time t (step S102: YES) is described. In this case, time is required for the low frequency energy to converge. Therefore, it is desirable to reduce the overall sense of volume in the low frequency range. Therefore, the applicable filter determining unit 232 determines the HPF unit 241 as the applicable filter. As a result, of the low frequency components L2, the low frequency component L2a of the period corresponding to the reverberation time RT, which is longer than the predetermined time t, is input to the HPF unit 241.

The HPF unit 241 calculates the center frequency at peak P included in the low frequency component L2a (step S103), forms a Butterworth-type HPF centered on the calculated center frequency, and applies this to the low frequency component L2a (step S104). As a result, the low frequency component L2a is cut off below the cutoff frequency set by the HPF unit 241. The low frequency component L2a′ after cutting is output to the synthesis unit 250.

In the synthesis unit 250, the high frequency component H and the low frequency component L2a′ are synthesized and output to the sound system 30. When music from the sound source 10 is finished (step S107: YES), processing of this flowchart ends; but if music of the sound source 10 is not finished (step S107: NO), processing of this flowchart returns to step S101.

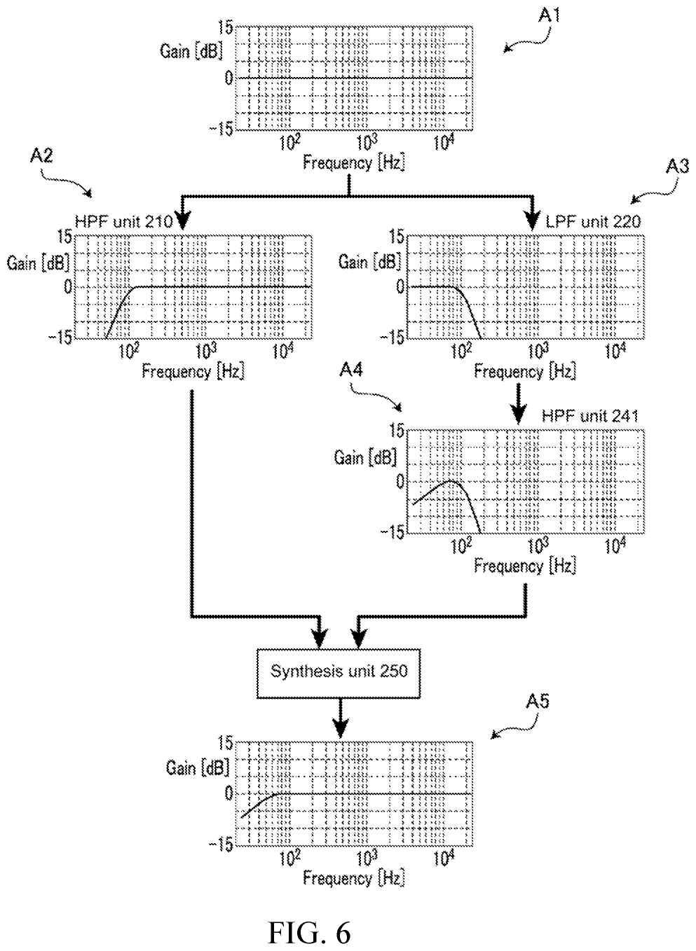

FIG. 6 is a diagram showing the frequency response of the audio signal when filter correction by the HPF unit 241 is applied. In FIG. 6, the graphs marked with the codes A1 to A5 illustrate the frequency response of the audio signal at each processing stage. The vertical axis of graphs A1 to A5 indicates gain (unit: dB), and the horizontal axis shows frequency (unit: Hz).

The original audio signal shown in Graph A1 has the low frequencies cut by the HPF unit 210 (see Graph A2) and the high frequencies cut by the LPF unit 220 (see Graph A3).

The low frequency component L2a after passing through the LPF unit 220 has the low frequency range cut by the HPF unit 241 (see graph A4). The low frequency component L2a′ after cutting and the high frequency component H are combined by the synthesis unit 250 to generate an audio signal in which virtually only the low frequencies are overall suppressed (see Graph A5).

Thus, low frequency components are cut in the HPF unit 241, which speeds up the convergence of low frequency energy, while moderately reducing the overall low frequency sense of volume. In addition, since the frequency response of the high frequency component H of the audio signal are virtually unchanged, the sound quality of the music improves while suppressing the effect on the sound balance.

In the present embodiment, the HPF unit 241 forms a Butterworth-type HPF. Therefore, a ripple is suppressed when the high frequency component H and the low frequency component L2a′ are combined.

The case in which the reverberation time RT of the low frequency component L2 is less than the predetermined time t (step S102: NO) is described. In this case, the low frequency range is dominated by sounds with momentarily high sound pressure, such as attack sounds. Therefore, it is desirable to correct only those portions of the low frequency range that have a strong attack, without reducing the overall volume of the low frequency range. Therefore, the applicable filter determining unit 232 determines the peaking filter unit 242 as the applicable filter. As a result, the low frequency component L2b of the period corresponding to the reverberation time RT, which is less than the predetermined time t, is input to the peaking filter unit 242.

The peaking filter unit 242 detects the frequency of peak P (peak frequency fp) included in the low frequency component L2b (step S105), forms a peaking filter with the detected peak frequency fp as the center frequency fc, and applies this to the low frequency component L2b (step S106). As a result, the low frequency component L2b near the center frequency fc is locally suppressed, and the suppressed low frequency component L2b′ is output to the synthesis unit 250.

The peaking filter unit 242 sets the suppression level at the center frequency based on the peak level at the peak frequency fp (or in other words, the level of peak P).

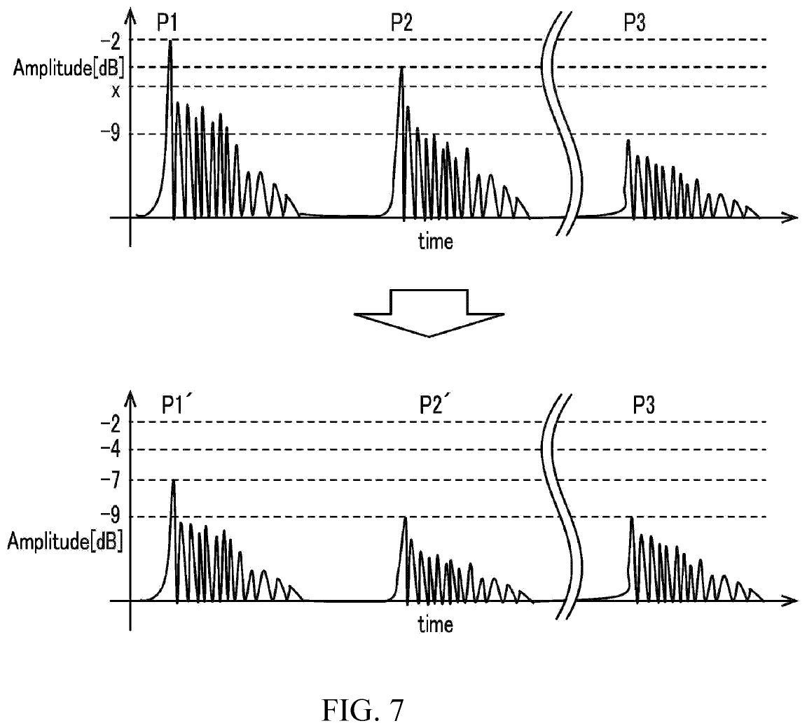

FIG. 7 is a diagram for describing an example of setting the suppression level of the peaking filter unit 242. In the example in FIG. 7, peaks P1 and P2 exceed the threshold value X, while peak P3 is below the threshold value X. The reverberation time RT corresponding to each waveform including peak P1 to P3 are all less than the predetermined time t.

In the present embodiment, the peak level that is the largest among the peaks exceeding the threshold value X is detected for the entire waveform, and the adjustment factor is set based on the detected maximum peak level. The set adjustment coefficient is applied to each waveform containing a peak that exceeds the threshold value X.

In the example in FIG. 7, the maximum peak level is −2 dB (see peak P1). The maximum sound pressure level to be targeted is −7 dB, when the maximum peak level is −2 dB.

In this case, the adjustment coefficient of the peaking filter is −5 dB (=−7 dB−(−2 dB)). Therefore, the waveform containing peak P1 is suppressed so that the level of peak P1 (−2 dB) is −7 dB (see code P1′). Similarly, the waveform containing peak P2 is also suppressed so that the level of peak P2 (−4 dB) is −9 dB (see code P2′). The waveform containing peak P3, which is below the threshold value X, is not peaking filtered.

In the synthesis unit 250, the high frequency component H and the low frequency component L2b′ are synthesized and output to the sound system 30. When music from the sound source 10 is finished (step S107: YES), processing of this flowchart ends; but if music of the sound source 10 is not finished (step S107: NO), processing of this flowchart returns to step S101.

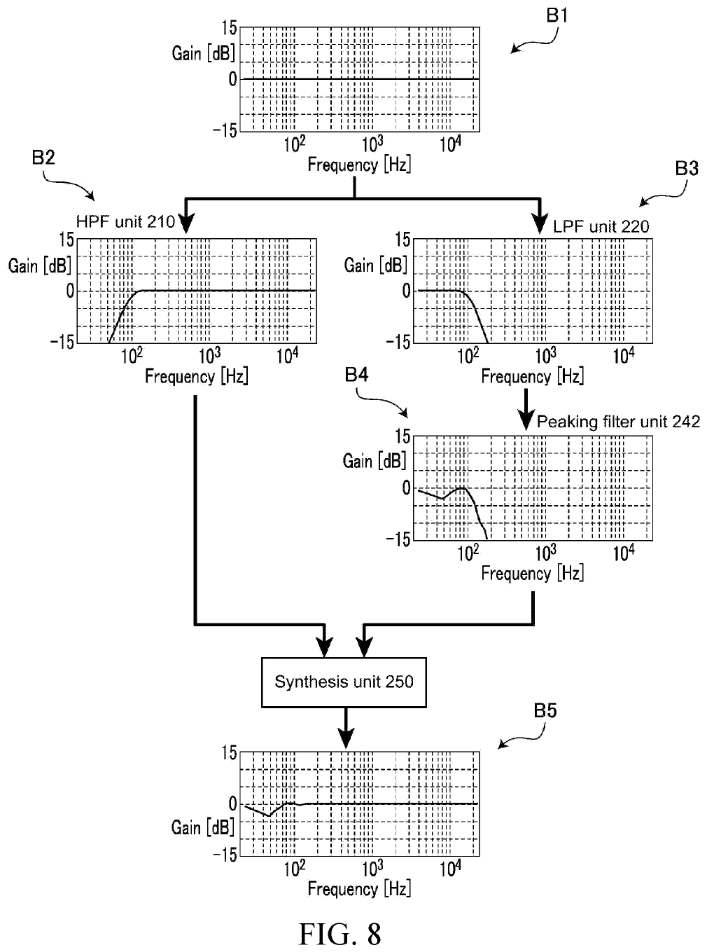

FIG. 8 is a diagram showing the frequency response of the audio signal when filter correction by the peaking filter unit 242 is applied. In FIG. 8, the graphs marked with the codes B1 to B5 indicate the frequency response of the audio signal at each processing stage. The vertical axis of graphs B1 to B5 indicates gain (unit: dB), and the horizontal axis indicates frequency (unit: Hz).

The original audio signal shown in Graph B1 has the low frequencies cut by the HPF unit 210 (see Graph B2) and the high frequencies cut by the LPF unit 220 (see Graph B3).

The low frequency component L2b after passing through the LPF unit 220 is locally suppressed in the low frequency range by the peaking filter unit 242 (see graph B4). The low frequency component L2b′ after local suppression and the high frequency component H are synthesized in the synthesis unit 250 to generate an audio signal in which substantially only localized portions within the low frequency range (portions with high sound pressure including peaks) are suppressed (see Graph B5).

Thus, only localized portions of low frequency components with high sound pressure are suppressed by the peaking filter unit 242, which moderately suppresses low frequencies that are strong to the auditory sense, suppresses distortion, and does not excessively weaken the sense of volume in the low frequency range. Therefore, the sound quality of the music can be improved while suppressing the impact on the sound balance.

The aforementioned is a description of an exemplary embodiment.

Embodiments of the present invention are not limited to those described above, and various modifications are possible within a scope of the technical concept of the present invention. For example, embodiments and the like that are explicitly indicated by way of example in the specification or combinations of obvious embodiments and the like are also included, as appropriate, in the embodiments of the present application.

For example, in the above embodiment, the peaking filter unit 242 locally suppresses the low frequency component L2b, but the configuration of the present invention is not limited to this case. In another embodiment, the peaking filter unit 242 can conceivably be configured to locally enhance the low frequency component L2b in order to improve sound balance.

The configuration of the filter correcting unit 240 is not limited to that shown in FIG. 2. As an example, a configuration in which a peaking filter unit is added to a later stage of the HPF unit 241 is also within the scope of the present invention.

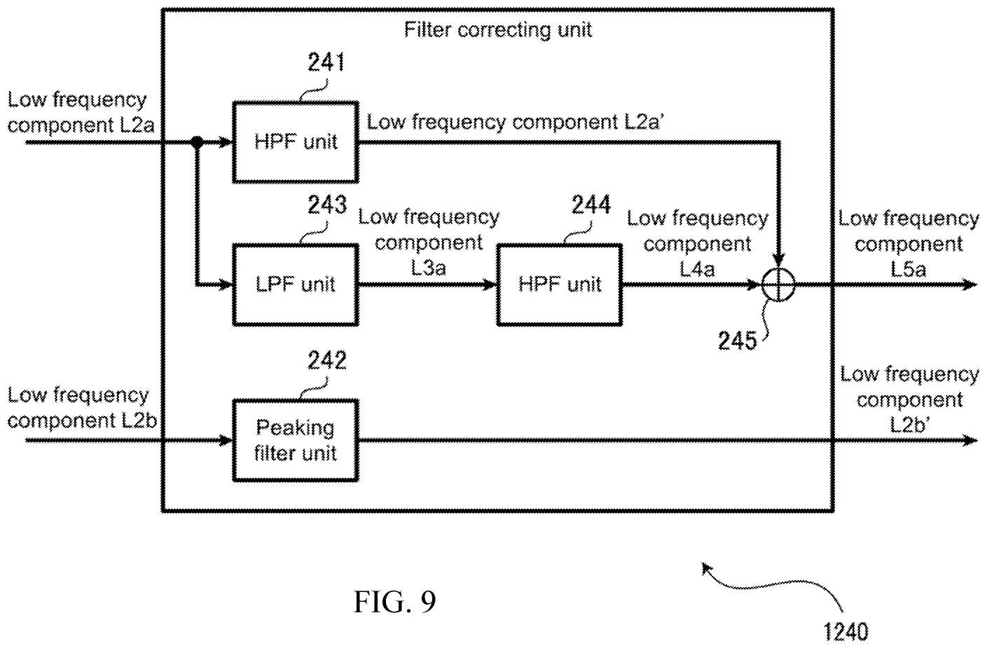

FIG. 9 is a functional block diagram of the filter correcting unit 1240 according to another embodiment. As shown in FIG. 9, the filter correcting unit 1240 includes an LPF unit 243, an HPF unit 244, and an adder 245, in addition to the HPF unit 241 and peaking filter unit 242.

As shown in FIG. 9, the low frequency component L2a input from the applicable filter determining unit 232 is also input to the LPF unit 243, which is arranged in parallel to the HPF unit 241. The center frequency at peak P included in the low frequency component L2a is calculated, and a Butterworth-type HPF centered at the calculated center frequency is formed in the HPF unit 241 and applied to the low frequency component L2a. Furthermore, the same center frequency-centered Butterworth-type LPF is formed in the LPF unit 243 and applied to the low frequency component L2a.

The HPF unit 244 cuts low frequency components within the low frequency component L3a input from the LPF unit 243 and outputs the cut low frequency component L4a. The adder 245 synthesizes the low frequency component L2a′ input from the HPF unit 241 and the low frequency component L4a input from the HPF unit 244, and outputs the synthesized low frequency component L5a to the synthesis unit 250.

In another embodiment, further LPF processing is applied in LPF unit 243 to the low frequency component L2a that has passed through the LPF unit 220 in order to more precisely suppress the target low frequency range and achieve further improvement in sound quality.

### REFERENCE NUMERALS USED IN THE DRAWINGS

1. Sound system
10. Sound source
20. Sound processing device
21. CPU
22. RAM
23. Flash ROM
30. Sound system
210. HPF unit
220. LPF unit
230. Reverberation detecting unit
231. Amplitude level determining unit
232. Applicable filter determining unit
233. Duration measuring unit
240. Filter correcting unit
241. HPF unit
242. Peaking filter unit
250. Synthesis unit

What is claimed is:

1. A sound processing device, comprising:
a first extracting unit for extracting a first frequency component from an audio signal;
a second extracting unit for extracting a second frequency component different from the first frequency component from the audio signal;
an amplitude level determining unit for determining if an amplitude level of the second frequency component exceeds a predetermined threshold value;
a duration measuring unit for measuring a duration during which the amplitude level continues above a predetermined level, when the amplitude level exceeds the predetermined threshold value;
an applicable filter determining unit for determining a filter unit to be applied to the second frequency component from a plurality of filter units, based on the duration measured by the duration measuring unit; and
a synthesis unit for synthesizing the first frequency component and a frequency component obtained by applying the filter unit determined by the applicable filter determining unit to the second frequency component.

2. The sound processing device according to claim 1, wherein
the plurality of filter units include a first filter unit that cuts a frequency component that is in a low range in the second frequency component; and
the applicable filter determining unit determines the first filter unit from the plurality of types of filter units as the filter unit to be applied to the second frequency component, when the duration exceeds a predetermined time.

3. The sound processing device according to claim 1, wherein
the plurality of filter units include a second filter unit that suppresses a specific frequency component of the second frequency component; and
the applicable filter determining unit determines the second filter unit from the plurality of filter units as the filter unit to be applied to the second frequency component, when the duration is less than a predetermined time.

4. The sound processing device according to claim 3, wherein
the second filter unit is a peaking filter unit; and
the peaking filter unit detects a peak frequency whose amplitude peaks in the second frequency component, and sets the detected peak frequency as a center frequency of the peaking filter unit.

5. The sound processing device according to claim 4, wherein
the peaking filter unit sets a suppression level at the center frequency based on a peak level at the peak frequency.

6. A sound processing method of causing a computer to execute a process, the process comprising:
extracting a first frequency component from an audio signal;
extracting a second frequency component different from the first frequency component from the audio signal;
determining if an amplitude level of the second frequency component exceeds a predetermined threshold value;
measuring a duration during which the amplitude level continues above a predetermined level, when the amplitude level exceeds the predetermined threshold value;
determining a filter unit to be applied to the second frequency component from a plurality of types of filter units, based on the duration measured; and
synthesizing the first frequency component and a frequency component obtained by applying the determined filter unit to the second frequency component.
